(19) United States
(12) Patent Application Publication
(10) Pub. No.: US 2024/0416935 A1
(43) Pub. Date: Dec. 19, 2024

(54) VEHICLE REACTION TIMER

(71) Applicant: William J. Boyko, Bath, PA (US)

(72) Inventor: William J. Boyko, Bath, PA (US)

(73) Assignee: Precision Reaction, LLC, BATH, PA (US)

(21) Appl. No.: 18/674,229

(22) Filed: May 24, 2024

Related U.S. Application Data
(60) Provisional application No. 63/504,616, filed on May 26, 2023.

(51) Int. Cl. B60W 50/06; B60W 50/10; B60W 50/14

(52) U.S. Cl. CPC B60W 50/06; B60W 50/10; B60W 50/14; B60W 2050/146; B60W 2520/105; B60W 2540/10; B60W 2540/12; B60W 2540/30

(57) ABSTRACT

Devices, methods, and processes for determining vehicle reaction time performance of vehicles of at least one component of reaction time performance, such as, for example, a rollout time determining electronic device or method.

### TECHNICAL FIELD

The present disclosure relates generally to reaction timers. More particularly, embodiments of the present disclosure relate to vehicle reaction timers for determining timing events of a vehicle following a driver's command to accelerate.

### BACKGROUND

In automotive drag racing of many forms, race teams, engineers, and drivers are always looking for the competitive edge to increase their chances of winning. Commonly, races can be won or lost by a few hundredths or thousandths of a second. With this small margin for error, reaction time consistency and/or reaction time quickness is vital for success. Reaction time is measured with the existing timers in the racetrack's timing system from when the starting light turns green until the vehicle rolls out of the starting line stage beam. This reaction time is a combination of the driver's reaction time to the green light to command the vehicle to accelerate and vehicle's reaction time to move out of the starting line stage beam following the driver's command to accelerate. Unfortunately, if a driver experiences inconsistent reaction times the driver may not know if the inconsistencies are from the vehicle or from the driver reducing the driver and/or race team's chances of finding problems of inconsistent and/or slow reaction times which leads to winning more races.

### BRIEF SUMMARY

In Embodiment 1 described herein, a device for determining the reaction time of a vehicle is disclosed. The device may have a signal receiver configured to accept electrical signals indicating the precise moment when the vehicle is commanded to accelerate or the precise moment when the vehicle's brake is released. The device may have at least one accelerometer configured to measure the acceleration of the vehicle. The device may have at least one microprocessor which may be electrically connected to the accelerometer. The microprocessor may be configured to calculate the elapsed time of timing events. The microprocessor may be configured to derive the vehicle's position based on the measured acceleration and recorded timing events in order to perform the derivation of position from the acceleration measurement as well as maybe calculate timing events such as elapsed times like vehicle rollout time. The microprocessor may also be configured to execute a method for determining vehicle rollout time, wherein the rollout time is defined as the elapsed time from the vehicle start time to the time when the vehicle reaches a predefined rollout distance from the vehicle starting position, utilizing the measured acceleration, derived vehicle position, calculated elapsed time, and electrical signals indicated from the signal receiver. The method for determining vehicle rollout time may start with the measured acceleration values from the accelerometer, and timing events such as say the current time, or the previous time when the previous acceleration measurement was taken. The method for determining vehicle rollout time may continue with the process of integration to compute velocity and continue again with the process of integration of velocity to calculate position. The method for determining vehicle rollout time may continue until the calculated position of the vehicle reaches the pre-defined rollout distance where the current time may be used to compare with the vehicle start time to determine the vehicle rollout time.

Timing events may be a single event that occurs in time such as the moment when the driver commands the vehicle to accelerate or also known as the driver commanded start time. Another timing event that would be classified as a single event that occurs in time is maybe vehicle start time. Driver commanded start time could be the moment when the driver commanded the vehicle to accelerate by maybe a momentary switch or a button or by releasing a brake or pressing an accelerator pedal. Timing events may also be calculated elapsed times also known as elapsed times such as maybe vehicle dead time or maybe vehicle rollout time, or maybe vehicle launch delay time. These timing events can be the length of time between two timing events measured by the microprocessor. The signal receiver is defined as any device, or system that is configured to receive electrical signals external to the device. For example, the signal receiver could be a conductor or a plurality of conductors which are able to conduct electricity from an outside source or the signal receiver could be a wireless electrical frequency receiver which is able to receive signals from electromagnetic frequencies.

Embodiment 2 is the device of embodiment 1 described herein, wherein the at least one microprocessor unit may be further configured to execute a method for determining vehicle dead time. The vehicle dead time is defined as the elapsed time from the vehicle start time to the time when the vehicle acceleration reaches a predefined threshold indicating initial movement. The microprocessor may utilize the measured acceleration, and the electrical signals indicated from the signal receiver to determine the vehicle dead time. The method for determining vehicle dead time may start by the microprocessor being with a pre-defined threshold of acceleration wait until the microprocessor receives an indication of a vehicle start time event and then measure acceleration values from the accelerometer. The method may continue by the microprocessor waiting and tracking the time until the measured acceleration is above the predefined threshold of acceleration maybe set by the user. Once the threshold of acceleration is met the method may continue with the microprocessor storing the current time and comparing with the vehicle start time.

In the context of this invention, the term “microprocessor” is used in a broad sense to encompass any computer device capable of executing instructions to perform various tasks. This includes not only traditional microprocessors but also other processing units such as microcontrollers, drivers, EEPROM chips, and similar computational components within the system. These devices collectively form the computational framework responsible for the operation and control of the system. The microprocessor, as broadly defined, serves as the central processing unit orchestrating the operation of the system. It may receive real-time acceleration data, compare it against predefined thresholds, compute timing events such as elapsed time, manage the user interface, control data storage, and access computer-readable media. Additionally, it could store data to externally removable media, providing flexibility in data management and transfer. Furthermore, other processors within the system, including drivers and EEPROM chips, contribute to its overall functionality. Together, these computational devices collaborate to ensure the seamless operation of the system, each contributing its specialized functionality to enhance overall performance and user experience. The term “microprocessor,” when used herein, encompasses this diverse array of computational components working in tandem to fulfill the objectives of the invention.

Embodiment 3 is the device of embodiment 1 described herein, where the at least one microprocessor unit may be further configured to execute a method for determining the vehicle's launch delay time. The launch delay time is defined as the elapsed time between the vehicle's driver commanded start time and vehicle start time, utilizing the electrical signals indicated from the signal receiver to determine the launch delay time. Launch delay time could be also referred to as delay time which may often be intentional by the driver. The driver may intentionally create this delay time with the use of a delay box or electronic time delay control box so the driver may have the ability to delay his reaction time.

Embodiment 4 is the device of embodiment 1 described herein, where the vehicle's driver commanded start time may be determined from a means of producing electrical signals from the position of the driver's accelerator pedal to determine the vehicle's driver commanded start time. An electrical signal may be produced by the driver at the accelerator pedal by the use of maybe a normally open switch or maybe a normally closed switch to indicate the driver has hit maybe full throttle percentage, half throttle percentage, or has left zero throttle percentage.

Embodiment 5 is the device of embodiment 1 described herein, where the vehicle start time may be determined from a means of producing electrical signals from the position of the driver's accelerator pedal to determine the vehicle's driver commanded start time. An electrical signal may be produced by the driver at the accelerator pedal by the use of maybe a normally open switch or maybe a normally closed switch to indicate the driver has hit maybe full throttle percentage, half throttle percentage, or has left zero throttle percentage.

Embodiment 6 is the device of embodiment 1 described herein, where the vehicle start time may be determined from a means of producing electrical signals from the driver's means of engaging or disengaging of the vehicle's transmission brake or transbrake. Engaging or disengaging the vehicle's transmission brake or transbrake may be seen as an event to determine the said vehicle's driver commanded start time.

Embodiment 7 is the device of embodiment 1 described herein, where the vehicle start time may be determined from a means of producing electrical signals from the vehicle's means of engaging or disengaging of the vehicle's transmission brake or transbrake to determine the said vehicle's driver commanded start time. Engaging or disengaging the vehicle's transmission brake or transbrake may be seen as an event to determine the said vehicle start time.

Embodiment 8 is the device of embodiment 1 described herein, wherein the vehicle start time may be determined from a means of producing electrical signals from the vehicle's means of engaging or disengaging of the vehicle's brake to determine the said vehicle start time. An electrical signal may be produced by the driver at the brake pedal by the use of maybe a normally open switch or maybe a normally closed switch to indicate the driver has released from maybe full brake percentage, half brake percentage, or has hit zero brake percentage.

Embodiment 9 is the device of embodiment 1 described herein, further comprising a circuit board comprising a means of mechanical and electrical connection between the at least one accelerometer, the signal receiver, and the at least one microprocessor which executes the method for determining vehicle rollout time, the method for determining vehicle dead time, and the method for determining vehicle launch delay time. The circuit board may serve as a means of mechanical structure to support the accelerometer as to not alter the force duce to acceleration in reference to the device.

Embodiment 10 is the device of embodiment 1 described herein which may further comprise of a housing for the means of mounting the circuit board which may contain the components of the device such as the accelerometer, microprocessor, and signal receiver. The housing may have a means of mechanical connection to the circuit board in at least one point of contact or a plurality of points of contact. The housing may be made of a single or plurality of materials configured to maintain structural integrity in order to ultimately support the accelerometer when its subject to the harsh environment of a racing vehicle.

Embodiment 11 is the device of embodiment 1 described herein, where the housing further comprises a cylindrically rounded geometric feature as a means to mechanically connect the said housing to the vehicle. The cylindrically rounded geometric feature may also be attached to a saddle for the purpose to serve as a solid mount to the vehicle.

Embodiment 12 is the device of embodiment 1 described herein, where the at least one accelerometer has at least one axis of acceleration measurement as in a single-axis accelerometer or a plurality of axis of acceleration measurement as in a two-axis accelerometer or as in a three-axis accelerometer.

Embodiment 13 is the device of embodiment 1 described herein, further comprising an electronic display electrically connected or connected via wireless communication to the microprocessor with means of displaying said vehicle's rollout time, vehicle's dead time, or vehicle's launch delay time in a numeric or alphanumeric format on the said device or external to the said device. This wireless communication may occur with electromagnetic frequencies or radio frequencies.

Embodiment 14 is the device of embodiment 1 described herein, may also have a means for displaying a numeric or alphanumeric format on said device comprising greater than two numeric or two alphanumeric digits. The display may serve the purpose of displaying timing events such as vehicle launch delay time, vehicle dead time, and vehicle rollout time.

Embodiment 15 is the device of embodiment 1 described herein, may also comprise of an electrical memory device electrically connected to the microprocessor in order to transfer information and store information electronically. Information that could be stored could be vehicle rollout time, vehicle dead time, and vehicle launch delay time. This information which is stored on the electrical memory device may also be cleared out by a sequence inputted into a user interface which may comprise of toggle switches on the device.

Embodiment 16 is the device of embodiment 1 described herein, where the electrical memory device can store multiple or more than one instance of vehicle's rollout time, vehicle's dead time, or vehicle's launch delay time and may display one or more instances of vehicle's rollout time, vehicle's dead time, or vehicle's launch delay time on the said electrical display in numeric or alphanumeric format.

Embodiment 17 is the device of embodiment 1 described herein, may also comprise of an electrical memory device electrically connected to the microprocessor in order to transfer information and store information electronically. The information may include storing multiple vehicle acceleration values during the run which may be referred to as “raw data”. in The raw data could be stored in order to be reviewed by the driver or an individual on the race team. The acceleration values may encompass the time after the vehicle start time event until the vehicle rollout time or continue on for a time period of 0.5 seconds or 1.0 seconds or 10 seconds.

Embodiment 18 is a device for mounting to a vehicle. The device may have a housing configured to act as an enclosure. The device may have at least one accelerometer configured to measure the acceleration of a vehicle. The device may have at least one microprocessor unit electrically connected to the at least one accelerometer. The device may have a circuit board that is mechanically attached to the at least one accelerometer, the at least one microprocessor, and the housing. The device may have a saddle configured to mount onto a vehicle's frame, the saddle having a cylindrical concave surface complementary to the curvature of a vehicle's frame for means of securing the saddle to the vehicle's frame. The housing may also have a cylindrical concave surface complementary to the vehicle's frame. The device may have a dampening structure formed of a material configured to reduce vibrations from the vehicle's frame, the dampening structure interposed between the housing to the saddle at one or more damping points to reduce externally induced vibrations from the vehicle.

Embodiment 19 may be a system comprising the device of any one of the embodiments 1-18.

Embodiment 20 may be a method for determining vehicle rollout time, dead time, and launch delay time using the device of any one of the embodiments 1-18.

### BRIEF DESCRIPTION OF THE DRAWINGS

While the specification ends with claims that specifically outline and identify what are considered to be embodiments of the present disclosure, the features and benefits of various embodiments may be better understood by reading the following description of example embodiments in conjunction with the accompanying drawings in which:

FIG. 1 is a perspective view of a vehicle reaction timer device in a first position according to an embodiment of the present disclosure;

FIG. 2 is a perspective view of a vehicle reaction timer in a second position shown with a means of mechanically connecting a vehicle reaction timer to a vehicle according to an embodiment of the present disclosure;

FIG. 3 is a side view of a vehicle reaction timer device according to an embodiment of the present disclosure;

FIG. 4 is a cross-sectional view of a vehicle reaction timer according to an embodiment of the present disclosure;

FIG. 5 is a graphical view of a relationship of timing events according to an embodiment of the present disclosure;

FIG. 6 is a flow diagram of a main program of a vehicle reaction timer according to an embodiment of the present disclosure;

FIG. 7 is a flow diagram of a menu program of a vehicle reaction timer according to an embodiment of the present disclosure;

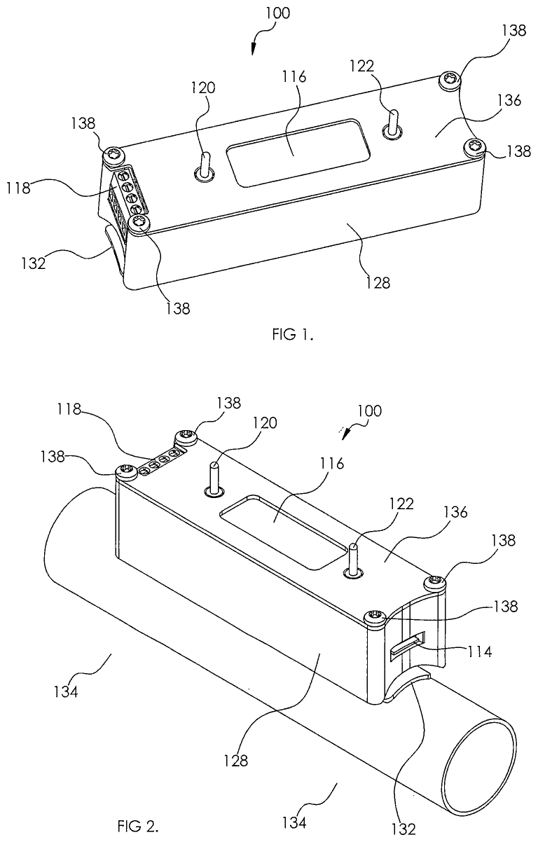

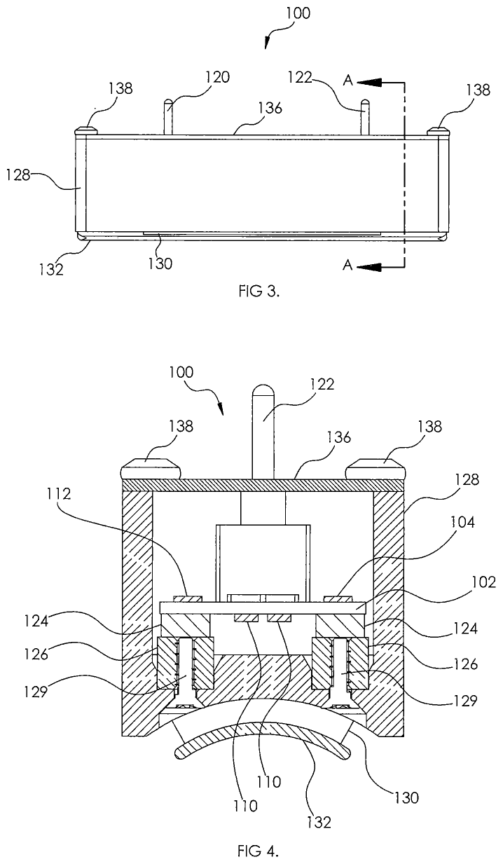

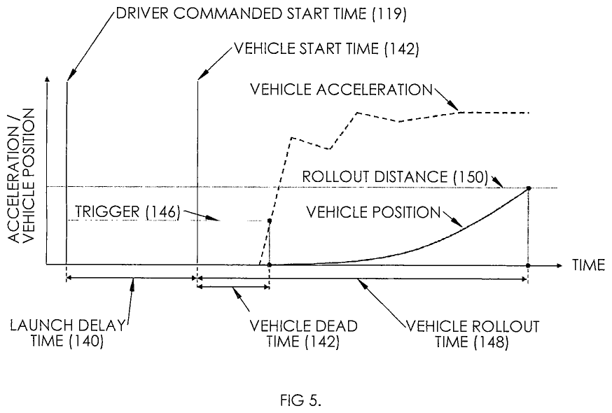

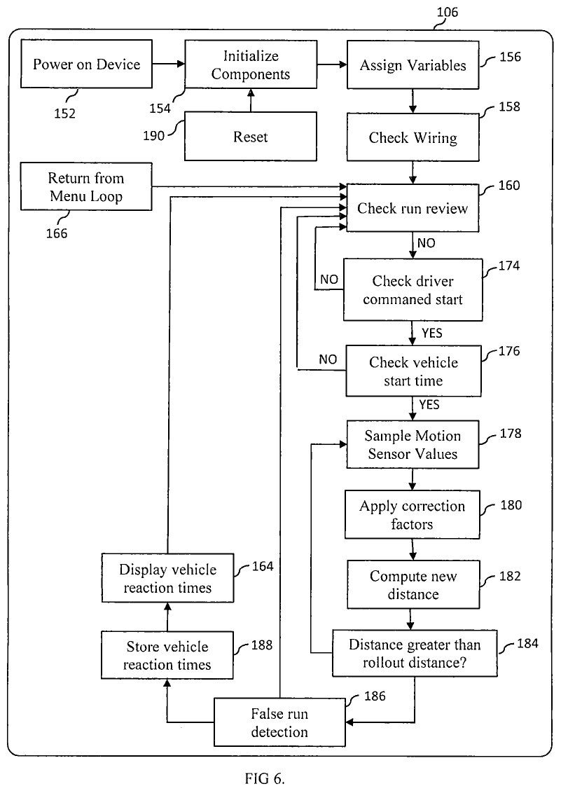

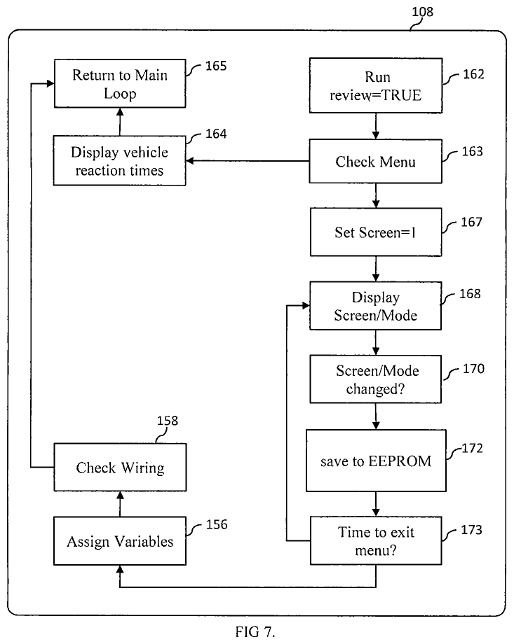

### DETAILED DESCRIPTION

### Introduction

The sport of drag racing has been needing an accurate and reliable device to determine vehicle reaction time in order to inform the driver of the source of inconsistent or slow reaction times. Reaction time is measured with the existing timers in the racetrack's timing system from when the starting light turns green until the vehicle rolls out of the starting line stage beam. This reaction time is a combination of the driver's reaction time to the green light to command the vehicle to accelerate and the vehicle's reaction time to move out of the starting line stage beam following the driver's command to accelerate. If the reaction time recorded by the racetrack's timing system is inconsistent, this could be due to a problem with the vehicle being inconsistent or the driver's reaction time being inconsistent. Regardless of the source of reaction time inconsistency, if the driver knows where the source of inconsistency is, then the driver or race team member can use this valuable information to attack the problem of inconsistency.

In some embodiments, vehicle reaction timers as disclosed herein may be similar to and include the various components and configurations of the vehicle reaction timers disclosed in U.S. Pat. No. 5,781,869 to Parlett, Jr. issued Jul. 14, 1998, the disclosure of which is hereby incorporated herein in its entirety by this reference. Vehicle reaction timers disclosed in this referenced prior art and/or other prior art may effectively measure and solve vehicle reaction time as it relates to dead time defined as the time it takes for a vehicle to begin movement following a vehicle start time event but may not effectively account for vehicle rollout time defined as the time it takes for a vehicle to roll out of the starting line stage beam following a vehicle start time event.

Drag racing reaction time inconsistencies of hundredths or thousandths of a second may arise before the vehicle begins to move and/or can arise after the vehicle has begun to move but before the vehicle travels the distance to move out of the starting line stage beam also known as rollout. Many forms of these inconsistencies described herein are large enough to affect the vehicle reaction time and cost the driver of losing the race. As much as only a few thousands of a second such as three or five thousandths of a second are sometimes enough to cost the driver of losing the race.

In some forms of drag racing measurement of vehicle reaction time and/or vehicle rollout time may not be attempted to be monitored due to low measurement accuracy and/or low measurement precision due to measurement errors. These measurement errors described herein associated with measuring rollout time with vehicle reaction timers can cause the accuracy and/or precision of a vehicle reaction timer to be in error by say, for example about ten thousandths or say about twenty thousandths of a second. This amount of error may be unacceptable as races are presently being decided by one or a few thousands of a second as described herein. A device described herein may have an ability to measure vehicle rollout time and/or vehicle reaction time within less than ten thousandths of a second giving valuable information to the driver and race team demonstrating an improvement to the prior art.

A device described herein may be capable of determining the full vehicle reaction time including but not limited to the vehicle launch delay time, vehicle dead time, and vehicle rollout time by monitoring the vehicles position versus time from the moment the driver commands the vehicle to accelerate until the vehicle reaches a pre-determined rollout distance. This full picture of vehicle reaction time gives feedback to the driver and/or race team after the race is completed to know what portion of the reaction time was due to the vehicle and which portion was due to the driver. If the device determines inconsistencies are from the vehicle, the driver may have access to which portion of the vehicle reaction time is showing inconsistencies such as the vehicle launch delay time, vehicle dead time, and vehicle rollout time. This gives the driver and race team valuable information to attack the problem and more confidence to the driver which leads to better reaction time performance and winning more races.

In the sport of drag racing sometimes reaction time quickness is more important than reaction time consistency. Reaction time quickness is most important in drag races when the rules of the race dictate that the first vehicle to cross the finish line first wins. This form of racing may commonly be known as heads-up or heads-up racing. The quicker the vehicle can accelerate down the racetrack increases the driver's chances of winning. Since the existing racetrack's timers start the elapsed timing clocks after the vehicle's front wheels roll out of the starting line stage beam, the driver and race crew may not know if the vehicle was slow to react or the driver was slow to react. In heads-up racing, races can normally be decided by a hundredth or a few hundredths of a second. If vehicle reaction time is found to be slow or is showing inconsistency it may cost the driver the race.

Drag racing reaction time consistency sometimes is more important than reaction time quickness. Reaction time consistency is most important in drag races when the rules of the race dictate a handicap system where a slower car can be just as competitive as a faster car. For example, in a drag race if a slower vehicle in a race normally runs the race in ten seconds but the faster vehicle runs the race in nine seconds, a handicap system can be put in place to stagger the starts of each vehicle so both the slower vehicle and the faster vehicle would reach the finish line at exactly the same time. This form of drag racing may commonly be known as bracket racing. In order to stagger the start of the race the Christmas tree may start the race for the slower car that runs the race in ten seconds exactly one second before the Christmas tree starts the race for the vehicle running the race in nine seconds. In bracket racing it is required of the driver to set their own predicted elapsed time. In bracket racing one rule of the race is that the driver cannot run faster than their predicted elapsed time so in the case of the car with a predicted elapsed time of 9.00 seconds if the driver gets to the finish line first but runs say for example 8.99 seconds that driver will lose the race. Bracket racing rules formed in this manner place less importance on the quickness of the vehicle and more importance on the consistency of the vehicle while placing the most importance on reaction time. Due to these rules of bracket racing with the importance taken out the quickness of the vehicle the margin for error is much smaller and races can normally be decided by only a thousandth of a second or a few thousands of a second. If vehicle reaction time is found to be inconsistent more than a few thousands of a second, it may cost the driver the race. If a driver has a device that could measure and record the vehicle reaction time it gives the driver the confidence when the vehicle reaction time is consistent and when the vehicle reaction time is inconsistent it alerts the driver of this issue so it could be quickly resolved when otherwise would have gone unnoticed.

In order to determine the full vehicle reaction time, the device must be able to measure rollout time. In order for rollout time to be measured the vehicle's position must be monitored accurately and precisely versus time from a standstill also known as the vehicle start time until the vehicle reaches a distance where the vehicle's front tires roll out of the starting line stage beam. This is commonly referred to as the rollout distance and can commonly be determined ahead of time by knowing the starting line stage beam height as well as the vehicle front wheel diameter and vehicle front wheel lateral stagger between the vehicles front wheels. In other words, the rollout distance is the amount of forward moving distance the vehicle needs to move from the position of the starting line stage beam hitting the front most portion of the front wheels to the position where the beam leaves the rear most portion of the front wheels. This rollout distance may be as long as a distance of say eight inches for a small front tire with a lower beam height or say eleven and a half inches for a standard size front tire and standard starting line stage beam height or even say twenty inches for a larger front tire with front wheel stagger and a higher starting line stage beam height.

In most forms of drag racing the racer may react to the starting line light fixture also known as the Christmas tree, which lets racers know when the car is properly positioned for a start and when to start. The typical sequence of a Christmas tree has three amber lights and a green light that may flash one after the other in 0.400 second intervals or 0.500 second intervals until the green light is illuminated. For example, say if the intervals were 0.500 second apart, the time from the first light being illuminated until the green light is 1.5 seconds.

In some forms of racing the racer may command the vehicle to accelerate on the third amber light giving the racer time to react to the third amber light and the vehicle time to react and rollout of the starting line stage beam. For example, if the driver reacts to the third amber light and the driver reaction time is 0.200 seconds, and the vehicle reaction time is 0.300 seconds, the vehicle will roll out of the starting line stage beam exactly when the light turns green giving the racer a perfect reaction time or a 0.000 reaction time. This form of reacting to the Christmas tree may commonly be called a bottom bulb launch.

Some drivers in drag racing may choose various methods to command their vehicle to start off a bottom bulb launch. One way a driver can command their vehicle to bottom bulb launch is first by holding the car stationary by simply pressing the vehicles brake pedal. When the driver reacts to the third amber of the Christmas tree the driver may simultaneously press the accelerator pedal fully while releasing the brake pedal fully in a quick manner. This action performed by the driver may commonly be called footbrake or footbraking or footbrake launch. It may sometimes be desired to determine when the driver's accelerator pedal is at a known position. In order to determine when the driver's accelerator pedal is at a known position a type of switch may be placed near the desired position that may produce electrical signals when the driver's accelerator pedal is at or near the desired position.

Another viable way to bottom bulb launch a vehicle is to first have an automatic transmission with a transmission brake installed in the vehicle also known as a transbrake. This transbrake may be able to hold the car stationary by holding the gear set of the transmission from rotating therefore holding the drive wheels from rotating. Some drivers prefer a transbrake over a traditional brake because the transbrake may be able to hold the vehicle stationary more securely. This may be required in order to spin the engine at a higher rotational speed which increases the stored energy in the vehicle in order to launch the vehicle with more force which may lead to quicker track times. In addition to the driver having a transbrake, the driver may also have a transbrake solenoid in order to control the transbrake. Typically, the transbrake solenoid either fully activates the transbrake or fully deactivates the transbrake with no modulation or proportionality. Typically, the transbrake solenoid is controlled electrically by a voltage source which may be on a switched circuit. A switch used to activate the transbrake solenoid may be used by the driver in the form of a button mounted in the vehicle cockpit near the driver also known as a transbrake button. If the driver has access to a button to control the switch, the driver can activate the transbrake solenoid with a button in the vehicle which also gives the driver a means of engaging or disengaging the vehicle's transbrake. If the driver wants to launch the vehicle, the driver may activate the switch with a button which with activate the transbrake solenoid which may activate the transbrake. The driver may then spin the vehicles engine to a higher rotational speed with higher vehicle stored energy also known as the launch rpm. When the third amber light is lit the driver can command the vehicle to start by deactivating the transbrake button which disengages the transbrake allowing the stored energy in the engine power to be transmitted through the transmission and to the drive wheels thereby launching the vehicle. This form of bottom bulb launching is commonly known as bottom bulb transbrake or transbrake launch or transbrake launching and could be a way for a driver to bottom bulb launch a vehicle.

Another viable way to bottom bulb launch a vehicle is if the vehicle is equipped with a device that is capable of connecting or disconnecting the engine from the transmission used to drive the vehicle. A clutch is a device commonly used to accomplish this by engaging with a sort of friction plate the engine rotating assembly to the transmission rotating assembly. The driver has control of this clutch and can engage or disengage it with the use of a clutch pedal, a third pedal in addition to the brake pedal and the accelerator pedal. Since in this situation there are three pedals and the driver only has two feet, it may be difficult to operate and launch the vehicle. To resolve this, a driver may use a switch that on the steering wheel commonly called a line-lock to operate a solenoid valve to hold brake pressure at a desired level. For example, the driver can position the vehicle at the starting line stage beam and press the brake pedal down until enough brake pressure is applied. Then the driver may press the line-lock switch and remove their foot off the brake pedal with brake pressure still held in the brake system by the line-lock switch. This may allow the driver to keep the vehicle stationary while using one foot for the accelerator pedal and one foot for the clutch pedal. While the vehicle is stationary at the starting line the driver can disengage the clutch by pressing the clutch pedal and increase the engine speed and stored energy. When ready to launch the driver can simultaneously release a brake pedal and/or a line-lock switch while releasing the clutch pedal and engaging the clutch to apply the stored energy in the engine to the transmission and to the drive wheels to launch the vehicle. This type of vehicle launch is commonly called a clutch launch, or clutch release launch or clutch release bottom bulb launch and could be used as a way to bottom bulb launch a vehicle.

In a bottom bulb launch the racer may command the vehicle to accelerate on the third amber light giving the racer time to react to the third amber light and the vehicle time to react and rollout of the starting line stage beam. However, while seemingly a simple task, for some drivers reacting on the third amber in a bottom bulb launch is difficult to do consistently because the driver may be distracted by the first and second amber lights while trying to focus on the third amber light. Bottom bulb launching is also difficult since there is a small margin to adjust the reaction time either with driver reaction time or vehicle reaction time. Changing driver reaction time may not be an easy task as it requires much time training the driver to react slower or quicker and also may not be as consistent as the driver simply reacting to a stimulus such as the illumination of a light bulb. Changing vehicle reaction time may not be an easy task since the vehicle may not work as consistently or may not accelerate as quick when trying to increase or decrease vehicle reaction time. Some classes in racing allow an electronic relay switching device that is used in series in the transbrake solenoid wiring circuit to control a delay time. The electronic switching device usually includes a relay to control the circuit in an on or off state, a timer to keep track of time, a switch for the driver to wire to the transbrake button in the vehicle and a programmable microprocessor that allows the driver to set a delay time in order to delay the release of the transbrake solenoid by a set time value. This device is commonly referred to as a delay box. With this delay box allowed in some drag racing classes the drivers can use a delay box and react to the first bulb in the Christmas tree which commonly increases the driver reaction time consistency. This allows the driver commanded start time of the vehicle to occur when the first light of the Christmas tree is illuminated and not the third. The driver then can adjust the delay time in the delay box to control how long until the vehicle's transbrake solenoid is deactivated after the driver reacts to the first amber light in the Christmas tree. With this adjustability in delay time the driver can select a delay time so that the vehicle is consistently launching and rolling out of the starting line stage beam as close to the time when the green light is illuminating on the Christmas tree. This places all emphasis on the driver to be consistent in driver reaction time and the vehicle to be consistent in vehicle reaction time since the delay time in the delay box can be increased or decreased to adjust for vehicle reaction time or driver reaction time. This form of launching a vehicle is commonly called top bulb, or top bulb launch. This form of launching may be used in bracket racing and may not be available to other classes in heads-up racing where vehicle reaction time quickness may play a larger role in the driver's success.

In some embodiments vehicle reaction timers may be utilized to record vehicle start time. Vehicle start time is the moment in time when the vehicle is commanded to accelerate. This command to accelerate may originate from the driver or may originate from another device such as a delay box. For example, the vehicle start time may be the moment the driver fully presses the accelerator pedal while simultaneously releasing the brake pedal in a footbrake launch of the vehicle. Also, for example, vehicle start time may be the moment the driver releases the transbrake button which disengages the transbrake allowing full engine power to transmit to the drive wheels in a transbrake launch of the vehicle. Also, for example vehicle start time may be the moment the driver releases the clutch pedal which engages the clutch which applies full engine power to the drive wheels in a clutch launch of the vehicle. Again, for example, vehicle start time may be the moment the delay box relay deactivates the transbrake solenoid which disengages the transbrake allowing full engine power to the drive wheels in a top bulb launch of the vehicle.

### Build

In some embodiments vehicle reaction timers may be made up of a plurality of identical and/or non-identical parts. For example, vehicle reaction timers may have multiple parts in the same single vehicle reaction timer which are identical in design. Also, for example, other parts in a vehicle reaction timer do not have identical parts in the same vehicle reaction timer as in a quantity of one.

In some embodiments vehicle reaction timers have parts that are constructed by either a single material or a plurality of materials. For example, a single vehicle reaction timer could have one part that could be made of one material and only one material while another part could be made of two or three or ten different types of material with no limitations.

In some embodiments a vehicle reaction timer 100 may have a circuit board 102 which serves to route any electrical connections to subcomponents mounted on the circuit board 102 and to transfer mechanical energy which could be in the form of mechanical vibration and/or mechanical motion, and also transfer thermal energy which could be in the form of heat energy or heat dissipation from subcomponents to other parts of the vehicle reaction timer 100.

In some embodiments vehicle reaction timers may have subcomponents mounted on the circuit board 102. One of these subcomponents a vehicle reaction timer 100 may have is a microprocessor 104. The microprocessor 104 can be electrically connected to the circuit board 102 in a plurality of points.

The microprocessor 104 may be a programmable electronic device which could be used to serve a plurality of functions and also could be used to communicate electrically with other subcomponents mounted on the circuit board 102. The microprocessor 104 may be programmable to perform multiple functions such as, for example, control what to read from inputs and/or sensors of the vehicle reaction timer 100 and how to read inputs and/or sensors of the vehicle reaction timer 100.

The microprocessor 104 may also perform tasks such as mathematical calculations from inputs and/or sensors and also display mathematical calculations to a display or store mathematical calculations to internal memory and/or to an external memory device and/or to a removable external memory device. The microprocessor 104 may have the ability to be user programmed and have the ability to store a set of instructions such as a first program named a main program 106, and a second program named a menu program 108 as described herein.

In some embodiments vehicle reaction timers may have subcomponents mounted on the circuit board 102. One of these subcomponents the vehicle reaction timer 100 may have is a motion sensor 110. The motion sensor 110 may have multiple internal subsystems such as accelerometers and/or gyroscopes to detect external motion of the motion sensor 110 and can all be integrated into a single silicon die commonly known as an integrated circuit with a plurality of electrical connection ports that could be interfaced with the circuit board 102.

In some embodiments vehicle reaction timers may have motion sensors that have an accelerometer mounted internally within the motion sensor 110. The accelerometer may have the capability of measuring the positive or negative force due to acceleration in a single axis of acceleration.

In some embodiments vehicle reaction timers may have motion sensors that have multiple accelerometers mounted internally in the motion sensor 110. The multiple accelerometers may have the capability of measuring the positive or negative force due to acceleration in a plurality of axes of acceleration which could be in the same axis and/or differently aligned axes such as, for example, an X-axis, a Y-axis, and maybe a Z-axis.

In some embodiments vehicle reaction timers may have motion sensors that have a gyroscope mounted internally in the motion sensor 110. The gyroscope may have the capability of measuring the positive or negative angular rotation rate in a single axis of angular rotation rate.

In some embodiments vehicle reaction timers may have motion sensors that have multiple gyroscopes mounted internally in the motion sensor 110. The multiple gyroscopes may have the capability of measuring the positive or negative angular rotation rate in a plurality of axes of rotation rate which could be in the same axis and/or differently aligned axes such as, for example, an X-axis, a Y-axis, and maybe a Z-axis.

In some embodiments vehicle reaction timers may have accelerometers that may mount directly to the circuit board 102 and not combined in a motion sensor subcomponent such as the motion sensor 110 described herein. The term accelerometer may refer to either an accelerometer that is mounted in the motion sensor 110 described herein or may refer to a stand-alone accelerometer that is mounted directly on the circuit board 102 and could be a single axis accelerometer or plurality of axes of accelerometers.

In some embodiments vehicle reaction timers may have gyroscopes that may mount directly to the circuit board 102 and not combined in a motion sensor subcomponent such as the motion sensor 110 described herein. The term gyroscope may refer to either a gyroscope that is mounted in the motion sensor 110 described herein or may refer to a stand-alone gyroscope that is mounted directly on the circuit board 102 and could be a single axis gyroscope or plurality of axes of gyroscope.

In some embodiments vehicle reaction timers may have subcomponents mounted on the circuit board 102. One of these subcomponents the vehicle reaction timer 100 may have is an EEPROM 112. The EEPROM 112 may be a form of memory that can store attributes and parameters of vehicle reaction timers and also store run data, motion sensor data, and elapsed times of run data such as, for example, launch delay time, vehicle dead time, and vehicle rollout time. In some embodiments the EEPROM 112 may be electrically connected to the circuit board 102 in order to be electrically connected to the microprocessor 104.

In some embodiments vehicle reaction timers may have subcomponents mounted on the circuit board 102. One of these subcomponents a vehicle reaction timer may have is a removable memory device 114. The removable memory device 114 may be a form of external memory that can store attributes and parameters of vehicle reaction timers and also store run data, motion sensor data, and elapsed times of run data such as, for example, launch delay time, vehicle dead time, and vehicle rollout time. In some embodiments the removable memory device 114 may be electrically connected to the circuit board 102 in order to be electrically connected to the microprocessor 104.

In some embodiments the removable memory device 114 may be removable by the user in order to view motion sensor data from the motion sensor 110 for a specific run or a plurality of runs. This motion sensor data could include data such as but not limited to acceleration data from the accelerometer, and angular rotation rate data from the gyroscope. This data may allow the user more information on how or why a vehicle reaction time such as a vehicle dead time or vehicle rollout time is not consistent or is varying from run to run or if a vehicle reaction time is slow or fast from one run to another run.

In some embodiments the removable memory device 114 may be removable by the user in order to view run data from the motion sensor 110 for a specific run or a plurality of runs. This run data could include data such as but not limited to vehicle launch delay time, vehicle dead time, vehicle rollout time, overall vibration levels from the motion sensor 110, overall rotation rate values from the gyroscope, a vehicle rollout time error value, or another data point of interest to the driver or user. This data may allow the user more information on how or why a vehicle reaction time such as a vehicle dead time or vehicle rollout time is not consistent or is varying from run to run or if a vehicle reaction time is slow or fast from one run to another run.

In some embodiments vehicle reaction timers may be able to display information in the form of a numeric or alphanumeric display or otherwise known as a display 116 in which the display 116 may be electrically connected to the circuit board 102 which may be electrically connected to the microprocessor 104 to view run data for a specific run or a plurality of runs directly on the device. The display 116 could be any means of displaying a numeric or alphanumeric format but not limited to a LED or LCD display. This run data could include data such as but not limited to vehicle launch delay time, vehicle dead time, vehicle rollout time, overall vibration levels from the accelerometer, overall rotation rate values from the gyroscope, a vehicle rollout time error value, or another data point of interest to the driver or user. This data may allow the user more information on how or why a vehicle reaction time such as a vehicle dead time or vehicle rollout time is not consistent or is varying from run to run or if a vehicle reaction time is slow or fast from one run to another run.

In some embodiments the display 116 used to display vehicle reaction times may be mechanically mounted directly to the circuit board 102 which is the same circuit board used to mount the microprocessor 104 or may be mounted externally on an external display to allow the driver or user to better visualize the data on the display 116. This may be required if the device which has the motion sensor 110 must be mounted in another location on the vehicle where the driver or user can't see the display 116.

In some embodiments this external display may be located externally on another device and/or could take the form of an existing display in say, for example, a data logger with a display or subcomponent of the vehicle with a data logger such as for example an engine management system with a display.

In some embodiments vehicle reaction timers may have a terminal block 118 electrically connected to the circuit board 102 in order to allow electrical energy to flow to a plurality of connection ports on the circuit board 102, to different subcomponents on the circuit board 102, and any and all other external devices that may be electrically connected to the circuit board 102.

In some embodiments the terminal block 118 may have a connection port to allow a voltage source to enter the circuit board 102. This voltage source could be supplied at a plurality of different voltage levels such as but not limited to twelve volts direct current, or sixteen volts direct current.

In some embodiments the terminal block 118 may have a connection port to allow a path to ground on the circuit board 102 for the means of completing an electrical circuit on the circuit board 102.

In some embodiments the terminal block 118 may have a connection port to allow a voltage signal from a device used to signal a driver commanded start time 119 such as for example, a transbrake button, or any device which would signal a driver commanded start time 119.

In some embodiments the terminal block 118 may have a connection port to allow a voltage signal from the device used to signal the vehicle start time 142 such as a transbrake solenoid, or a full throttle switch, or any device which would signal a driver commanded start time 119.

In some embodiments vehicle reaction timers may have a diode or a plurality of diodes in order to limit the current flow in one direction or a positive direction to protect subcomponents on the circuit board 102 if current were to flow in a negative direction. These diodes may also provide protection for other external subcomponents such as vehicle subcomponents mounted separately from the vehicle reaction timer 100 in the vehicle say for example, delay boxes but not limited to other devices.

In some embodiments vehicle reaction timers may have a voltage regulator electrically connected to the circuit board 102 which may supply a regulated voltage power supply to subcomponents on the circuit board 102. For example, the voltage regulator may regulate voltage to a level of five volts to power the display 116 of the vehicle reaction timer 100. There may also be a plurality of voltage regulators which allows for multiple levels of voltage regulation for different components requiring different supply voltages on the vehicle reaction timer 100.

In some embodiments vehicle reaction timers may have a plurality of user-interface controls which may be in the form of a left control switch 120 or a right control switch 122. The left control switch 120 may be a multiple position switch, say for example, a two-position switch or a three-position switch. The right control switch 122 may also be a multiple position switch, say for example, a two-position switch or a three-position switch. The purpose of the switch may be to control a plurality of functions such as but not limited to, run review cycling, resetting the device or power cycling the device, controlling the menu, menu screen, and menu selection, user calibration, run review deletion, and controlling what vehicle reaction time data to display on the display 116.

In some embodiments vehicle reaction timers may have a dampening system in order to reduce or eliminate mechanical vibrations that cause error to accumulate in vehicle rollout time determining electronic devices. The dampening system may comprise of an isolator 124 which may be a mechanical isolation device mechanically connected to the circuit board 102 in one or a plurality of locations, say for example, four locations. Each instance of the isolator 124 may also be mechanically connected to an isolator block 126. Each instance of the isolator block 126 may be mechanically connected to a housing 128. The circuit board 102 may be mechanically connected to a plurality of isolators 124 as described herein with a plurality of corresponding isolators blocks 126 as described herein which may all be mechanically connected to the housing 128 each with a isolator block screw 129. The housing 128 may be mechanically connected to a housing isolator 130. The housing isolator 130 may be mechanically connected to a mounting bracket 132. The mounting bracket 132 may be mechanically connected to the vehicle with mounting hardware 134.

In some embodiments the term “mechanical connection” may mean any and all types of mechanical connection both permanent types, semi-permanent, and non-permanent. For example, the term “mechanical connection” may comprise of a bolted connection with a screw or a nut and bolt, an adhesive connection, or it may mean a type of with a type of mechanical bolt or screw.

The mechanical connection between the circuit board 102 and the isolator 124 may be a plurality of types of connections such as, for example, an adhesive connection and/or a bolted connection. The mechanical connection between the isolator 124 and the isolator block 126 may be a plurality of types of connections such as, for example, an adhesive connection and/or a bolted connection. The mechanical connection between the isolator 124 and the isolator block 126 may be a plurality of types of connections such as, for example, an adhesive connection and/or a bolted connection.

The isolator 124 and the housing isolator 130 may be made from a plurality of materials and may be made from a material such as, for example, rubber, or any elastic material with mechanically isolating properties. The isolator block 126 and housing 128 may be made from a plurality of materials and may be made from a material such as, for example, plastic or aluminum. The housing 128 may be shaped in a plurality of different shapes but commonly may be shaped to not protrude into the cockpit of a vehicle which would be intrusive to the user or driver of the vehicle.

In some embodiments the housing 128 may have an external memory window feature such as to serve a purpose of allowing the removal of the external memory device 114. If the housing 128 were to not have the external memory window feature, then the external memory could be difficult to remove by the user or driver.

In some embodiments the housing 128 may have a terminal block opening feature such as to serve a purpose of allowing wiring connections to the terminal block 118. If the housing 128 were to not have the terminal block 118 opening feature, then it would make it difficult for the driver or the user to make the wiring connections to the device.

The housing 128 may be sized larger than the size of the circuit board 102 within the housing 128 in order to allow the circuit board 102 to move in order for the isolators 124 to move in order to dampening mechanical vibration.

In some embodiments of vehicle reaction timers there may be a protective coating which may be applied to the circuit board 102 after all mechanical and electrical connections are made in order to protect the circuit board 102 connections from deteriorative forces such as, for example, but not limited to, corrosion and/or electrolyte solution induced short circuits.

In some embodiments of vehicle reaction timers there may be a cover 136 which may be mechanically connected to the housing 128 in at least one location or a plurality of locations or points. The cover 136 may be connected with the use of a cover screw 138 or a plurality of cover screws, the cover screw 138 may serve to clamp the cover to the housing 128 since the housing 128 may have undersized holes for the screw or screws to thread into. The cover 136 may serve as a resistive barrier to protect the circuit board 102 from external deteriorative forces and may serve as a first line of defense wherein the protective coating may serve as a second or may serve as a last line of defense. The cover 132 may be made from a plurality of materials such as but not limited to, aluminum, plastic, or composite.

In some embodiments the cover 136 may have a window opening feature to allow the user or driver to see the display 116. The window opening feature may be a plurality of shapes but may be typically sized according to the size of the display 116.

In some embodiments the cover 136 may have holes or opening features for the control switches as described herein as the left control switch 120 and the right control switch 122. The holes may be round and may be oversized to allow the circuit board 102 to move in order for the isolators 124 to move in order to dampening mechanical vibration.

In some embodiments the cover 136 may have opening features for the terminal block 118 as described herein in order as to serve a purpose of allowing wiring connections. The opening features may be oversized to allow the circuit board 102 to move in order for the isolators 124 to move in order to dampening mechanical vibration.

In some embodiments the mounting bracket 132 may be a plurality of shapes. For example, the mounting bracket 132 could have a cylindrical shape to conform to a tube commonly found on a drag racing vehicle chassis or vehicle chassis but may also be a flat shape to mount on a flat portion of a vehicle chassis. The mounting bracket 132 may also be made from a plurality of materials such as, for example, aluminum or steel but could be made from plastic or other materials which have compatibility with the housing isolator 130 and the vehicle chassis.

In some embodiments if the mounting bracket did not fit the mounting location of the vehicle, it could be possible to create an adapter bracket to attach the mounting bracket 132 to the adapter bracket and the adapter bracket to the vehicle. The adapter bracket maybe able to adapt the surface profile of the mounting bracket 132 to the surface profile of the mounting location of the vehicle.

### Timing Events

In some embodiments vehicle reaction timers may be utilized to record a launch delay time 140 of a vehicle or drag racing vehicle. Drivers who utilize a top bulb launch and a delay box device may often want to know if the delay time programmed in the delay box matches the launch delay time 140 recorded by the vehicle reaction timer 100. The launch delay time 140 may be the elapsed time from the driver commanded start time 119 until a vehicle start time 142 is reached. The launch delay time 140 may be a crucial parameter for controlling the vehicle launch timing without changing the driver reaction time. The launch delay time 140 may often be desired by the driver in order to control a vehicle launch delay cycle prior to launching the vehicle and/or the vehicle start time 142 to better control the vehicle launch timing without changing the driver reaction time.

Changing driver reaction time may not be an easy task as it requires much time training the driver to react slower or quicker and also may not be as consistent as the driver simply reacting to a stimulus such as the illumination of a light bulb. The launch delay cycle may be performed using a delay box, a device commonly used in drag racing, which delays the vehicle start time 142 following the driver commanded start time 119. The driver commonly has access to program the delay box to a specific launch delay cycle time. The driver commanded start time 119 when used with a delay box may be initiated by the driver by a separate device called a transbrake button. This transbrake button may allow the driver to let go of a button or push a button and increase the consistency of the driver reaction time.

The device disclosed herein measures the launch delay time 140 by measuring the elapsed time from the driver commanded start time 119 until the vehicle start time 142 is reached at the end of the launch delay cycle. Vehicle start time 142 may be the moment the vehicle is commanded to accelerate by the delay box completing its launch delay cycle. Since this launch delay cycle may be susceptible to inconsistencies and may be inconsistent with the driver's programmed delay time, it may be crucial to record and maintain an accurate and consistent launch delay time 140 to ensure a consistent vehicle reaction time.

In some embodiments vehicle reaction timers may be utilized to record a vehicle dead time 144 of a vehicle or drag racing vehicle. When drag racing vehicles are launched as discussed herein there may be a time called the vehicle start time 142 when the vehicle is commanded to accelerate. This command to accelerate comes from either the driver in say, for example, a footbrake, transbrake or clutch launch or from a device in the vehicle say, for example, a delay box in a top bulb launch. After the vehicle start time 142 event depending on the construction and architecture of the vehicle there may be a dead time or waiting period until any movement occurs. This waiting period or dead time can be due to multiple factors such as for example the inertia of the transbrake solenoid and the inertia of the spool valve in the transmission brake valve body which both could cause a fluid signal delay in say an automatic transmission. The length of time may vary from vehicle to vehicle but may be, for example, about 0.010 seconds or about 0.030 seconds or about 0.055 seconds.

In order to determine when the first sign of movement or the time when initial movement is detected or occurs in the vehicle a sensor must be used to measure the acceleration such as an accelerometer. When the acceleration levels from the accelerometer have reached a set threshold known as a dead time trigger 146 event, the elapsed time from the vehicle start time 142 to the dead time trigger 146 event may be the vehicle dead time 144. This dead time trigger 146 and its set trigger value could be set from a plurality of values but may commonly be on the order of one-half times earth's gravity or one times earth's gravity.

Due to the plurality of moving parts in a drag racing vehicle and other factors exterior to the vehicle, vehicle dead time 144 may be susceptible to inconsistencies and may affect a vehicle rollout time and/or reaction time, it may be crucial to record and maintain an accurate and consistent vehicle dead time 144 to ensure a consistent vehicle reaction time. The device disclosed herein may measure the vehicle dead time 144 by measuring the time from when the vehicle start time 142 event occurs to when the vehicle triggers the dead time trigger 146 threshold.

In some embodiments vehicle reaction timers may be utilized to record a vehicle rollout time 148 of a vehicle or drag racing vehicle. When drag racing vehicles are launched as discussed herein there may a time called the vehicle start time 142 when the vehicle is commanded to accelerate. This command to accelerate comes from either the driver in say for example a footbrake, transbrake or clutch launch or from a device in the vehicle say for example a delay box in a top bulb launch. After the vehicle start time 142 event the vehicle may experience a dead time as discussed herein where no acceleration occurs.

Then after a dead time has passed the vehicle may begin to experience acceleration enough to trigger the dead time trigger 146. At this point the vehicle usually hasn't moved more than one percent of the total distance that needs to be traveled for the front wheels to roll out of the starting line stage beam. As the vehicle continues to accelerate and the position of the vehicle beings to move closer to a rollout distance 150 many factors can affect the level of acceleration and the consistency of acceleration before the vehicle reaches the rollout distance 150.

These factors may be but not limited to the transmission and converter temperatures, features, and condition of the converter such as fin angles, and features and condition of the transmission such as clutch pack clearances, and transmission band setpoint in an automatic transmission. In a vehicle equipped with a clutch factors such as the clutch plate's condition and clearances in the clutch pack as well of the condition thereof play a bigger role.

Aside from factors from the transmission, other factors may affect the consistency of acceleration that are on the chassis of the vehicle such as but not limited to suspension dampers or shock absorbers, tire sidewall condition, and tire grip. Since there are many factors to affect the level and consistency of acceleration through the entire rollout distance 150 it may be critical to measure rollout time in order to ensure the vehicle reaction time is consistent and/or as quick as possible.

In order to measure the distance and/or rollout distance 150 the vehicle has traveled the device described herein measures the acceleration from the point of the vehicle start time 142 and measures the acceleration of the vehicle with time to determine the vehicles position through a process called double integration which integrates the acceleration over time to determine velocity then integrates velocity over time to determine position. This process of double integration may also commonly called dead-reckoning and if the initial position is known the current position can be determined through double integration. The initial position in this case may be the position at the vehicle start time 142 which may be zero.

The rollout distance 150 may be a set distance in the device by the driver or crew member depending on what the rollout of the vehicle is. As discussed herein the rollout distance 150 can be different for every vehicle. This rollout distance 150 may be as long as a distance of say eight inches for a small front tire with a lower beam height or say eleven and a half inches for a standard size front tire and standard starting line stage beam height or even say twenty inches for a larger front tire with front wheel stagger and a higher starting line stage beam height. The device disclosed herein measures the vehicle rollout time 148 by measuring the time from when the vehicle start time 142 event occurs to when the vehicle position reaches the set rollout distance 150.

In some embodiments the microprocessor 104 may include a process for determining the vehicle rollout time 148. The microprocessor 104 when used as a device to determine vehicle rollout time 148 can also be referred to a as a vehicle rollout time determining electronic device. A vehicle rollout time determining electronic device may be any device that determines vehicle rollout time 148 or the elapsed time it takes for a vehicle to travel the rollout distance 150. The rollout distance 150 may be different for each vehicle for example, the rollout distance 150 may be about eleven and a half inches or may be about eight inches or may be about twenty inches depending on the vehicle's configuration.

In some embodiments the microprocessor 104 may include a process for determining the vehicle dead time 144. The microprocessor 104 when used as a device to determine vehicle dead time 144 can also be referred to a as vehicle dead time determining electronic device. A vehicle dead time determining electronic device may be any device that determines vehicle dead time 144 or the elapsed time it takes for the vehicle to experience movement following a driver's commanded start time or a vehicle start time 142 event which could occur after a driver's command to accelerate.

In some embodiments the microprocessor 104 may include a process for determining launch delay time 140. The microprocessor 104 when used as a device to determine launch delay time 140 can also be referred to a as a launch delay time determining electronic device. A launch delay time determining electronic device may be any device that determines vehicle launch delay time 140 which may be the elapsed time from a driver's command to accelerate to a vehicle start time event.

Embodiments of the present disclosure as described herein may be capable of determining the full vehicle reaction time including but not limited to the vehicle's launch delay time 140, vehicle dead time 144, and vehicle rollout time 148 by monitoring the vehicles position versus time from the moment the driver commands the vehicle to accelerate until the vehicle reaches a pre-determined rollout distance 150. This full picture of vehicle reaction time gives feedback to the driver and/or race team after the race may be completed to know what portion of the reaction time was due to the vehicle and which portion was due to the driver. If the device determines inconsistencies are from the vehicle, the driver may have access to which portion of the vehicle reaction time may be showing inconsistencies such as the vehicle launch delay time 140, vehicle dead time 144, and vehicle rollout time 148. This gives the driver and race team valuable information to attack the problem and more confidence to the driver which leads to better reaction time performance and winning more races.

### Software

In some embodiments the vehicle reaction timer 100 may have a main program 106 for the microprocessor 104 to follow a set of instructions in order to complete tasks of the vehicle reaction timer 100 such as but not limited to measure, record, and display vehicle reaction times. If power is applied to the device a voltage regulator may apply power to the microprocessor 104 which may start the main program 106 in a power on device sequence 152. The power on device sequence 152 may be pre-programmed by the microprocessor 104 manufacture in a standard practice understood by someone of ordinary skill in the art.

After the power on device 152 sequence the main program 106 may enter into an initialize components 154 section where setup functions of the motion sensor 110 including setup of the accelerometer and gyroscope are completed. Initialize components 154 may also set the address of the other components on the board in order to establish communication such as the EEPROM 112, a removable memory device 154, and a display driver device to drive the display 116.

In some embodiments the main program 106 for the microprocessor 104 may exit the initialize components 154 section and enter an assign variables 156 section. The assign variables 156 section may read stored information such as launch mode information, calibration information, vehicle mounting orientation information, a user programmed rollout distance 150, a user programmed starting angle, a user programmed acceleration threshold, and an array of stored run data including but not limited to vehicle reaction times from the EEPROM 112.

Launch mode information obtained from the EEPROM 112 may be used to set a launch mode of the vehicle reaction timer 100 to determine in the main program 106 how and when driver commanded start time 119 and vehicle start time 142 is signaled. For example, in a top bulb launch if a delay box used requires a positive voltage signal to pass through the transbrake button into the transbrake button circuit of the delay box, the launch mode can determine that a positive voltage means the driver is pressing the transbrake button and also that a negative voltage means the driver is not pressing the transbrake button. Also, for example, if the delay box used requires the transbrake button circuit to be connected to electrical ground then a positive voltage signal means the driver is not pressing the transbrake button and a negative voltage signal means the driver is pressing the transbrake button.

The launch mode then determines what the order of operations could be to detect a start signal for timing events such as the driver commanded start time 119 or the vehicle start time 142. If the driver configures a delay box to start a race by pushing the transbrake button or releasing the transbrake button the launch mode could have different order of operations to signal the driver commanded start time 119 and vehicle start time 142.

MEMS type motion sensors with accelerometers and gyroscopes may be inaccurate if not properly calibrated. Calibration information obtained from the EEPROM 112 may be used to set calibration scaling and offset in the main program 106 to ensure a more accurate acceleration and rotational velocity reading. This calibration information may be determined and stored by say for example, the manufacture of the vehicle reaction timer 100.

The driver or crew member may want to mount the vehicle reaction timer 100 in a different orientation in order to better read the information on the display 116 of the reaction timer or mounting in a different orientation may offer a better location in the vehicle. In some embodiments vehicle mounting orientation information obtained from the EEPROM 112 may be used to set the orientation of the motion sensor 110 to determine in the main program 106 which axis to use for example on a multi axis accelerometer or gyroscope, or the direction of an axis on an accelerometer or gyroscope.

In some embodiments user programmed values in the EEPROM 112 may be used to configure the main program 106 such as rollout distance 150. Rollout distance 150 may be set to a custom value since the rollout distance 150 may be different for all types of vehicles. Another example of a user programmed value is an acceleration threshold used as a trigger in the dead time determining electronic device.

In some embodiments after the assign variables 156 section is complete the main program 106 may move to a check wiring 158 section. The check wiring 158 section may check the voltage at the button and transbrake terminals of the vehicle reaction timer 100 and compare with the launch mode set in the assign variables 156 section. If the wiring does not have the correct polarity as in a positive voltage or a negative voltage present which should be present depending on the launch mode, then the check wiring 158 section may report an error to signal the driver or crew member that there may be a wiring or connection issue and/or a user programming issue.

In some embodiments after the check wiring 158 section, the main program 106 may check if the user has requested to review a run or cycle to a previous run to be reviewed in a check run review 160 section. In some embodiments if the check run review 160 is true the microprocessor 104 may move to a menu program 108 starting at a run review true 162 section. If the user decides to review a run or cycle to another run stored on the EEPROM 112 the user may activate the left control switch 120 such as pressing the left control switch 120 and then a short time later may release the left control switch 120. This short time could be a time greater than a few thousandths of a second but less than say, for example, three seconds, or five seconds.

In some embodiments this may cause a check menu 163 section to move the menu program 108 to a display vehicle reaction times 164 section where the microprocessor 104 may then either begin displaying the vehicle reaction times or cycle to the next previous run of vehicle reaction times. After displaying the vehicle reaction times the menu program 108 will move to a return to main program 165 section where the microprocessor 104 will jump back to the main program 106 at a return from main program section 167. From the return from main program 167 section in the main program 106 the main program 106 may move back to check run review and continue looping through display vehicle reaction times 164 for a plurality of runs while the display vehicle reaction times 164 section is active.

In some embodiments if the user wants to instead however enter into the menu the user may hold the left control switch 120 forward for a longer time period for say three seconds or maybe five seconds until the check menu 163 section of the menu program 108 determines to move the menu program 108 to a set a screen of the menu equal to one 167 in order to maybe always start a menu screen from screen one. Then the menu program 108 may move on to a display of the current screen and mode 168, where the display 116 may report to the user what menu screen is active and what corresponding mode of the display 116 menu screen is selected.

In some embodiments the control switches could be used to change the mode of the current screen and/or change the screen to the next or previous screen. The menu program 108 checks for any of these changes in a screen or mode change 170 section. In some embodiments of screen or mode change 170 section if a change is detected the program may save the new screen and mode in the EEPROM 112 memory in a save to EEPROM 172 section.

In some embodiments of the menu program 108 the menu program 108 may check if no change has been made to the screen and/or mode for more than a set time period in a time to exit menu 173 section. The set time period may be of say fifteen seconds or say twenty seconds or thirty seconds then the menu program 108 may run the assign variables 156 section and check wiring 158 section and be exited to return to the main program 106 from the return to main program 165 section.

In some embodiments of the main program 106 if the check run review 160 section is false then the main program 106 may check for a start command in a check driver commanded start time 174 section. In this section if the program detects a driver commanded start time 119 event the program may save a time-step value for future computations such as the launch delay time 140.

In some embodiments of the main program 106 if the check driver commanded start time 174 section does not detect a driver commanded start time 119 the program may return to the check run review 160 section.

In some embodiments depending on the launch mode for example a footbrake launch the check driver commanded start time 174 section may be passed straight to a check vehicle start time 176 section.

In some embodiments of the check vehicle start time 176 section if a vehicle start time 142 event is detected the main program 106 may save to internal memory the current time and save it as the vehicle start time 142 for future computations such as the launch delay time 140, or vehicle dead time 144 or vehicle rollout time 148.

In some embodiments the vehicle start time 142 or driver commanded start time 119 may be falsely detected which could result in an incorrect launch delay time 140 and/or vehicle dead time 144 and/or vehicle rollout time 148. In some embodiments the vehicle start time 142 section may preliminary compute vehicle launch delay time 140 using the elapsed time between vehicle start time 142 and driver commanded start time 119 and if the value is smaller than a set value of time such as 0.001 seconds or 0.0005 seconds then the program may return to the check run review 160 section.

In some embodiments of the main program 106 if the check vehicle start time 176 section does not detect a vehicle start time 142 the program may return to the check run review 160 section.

In some embodiments if a vehicle start time 142 event is detected in the check vehicle start time 176 section, then the main program 106 may move to a sample motion sensor values 178 section. The sample motion sensor values 178 section may read the acceleration and gyroscope values from the motion sensor 110 and/or a second motion sensor and the current time value from a timer internal to the microprocessor 104.

In some embodiments if the acceleration and gyroscope values from the motion sensor 110 and/or timer from the microprocessor 104 are read, the main program 106 may apply correction factors with a means of correction to vehicle acceleration in a apply correction factors 180 section. Correction factors may be derived from a plurality of sources such as calibration information, device mounting orientation information, and vehicle angular orientation which may be stored in the assign variables 156 section. Calibration information may be used if the accelerometer's output has error associated with the sensitivity of the accelerometer or the zero-offset of the accelerometer. For example, if the accelerometer is at rest and is oriented with its measurement axis in the direction parallel to earth's gravity the acceleration should read zero acceleration. In this scenario many accelerometers supplied from the manufacture may have some acceleration value either positive or negative but since at rest and not in the direction of earth's gravity should read zero acceleration. This may commonly be referred to as zero-offset calibration which could be stored in the assign variables 156 section. Also, for example, if the accelerometer is at rest but its measurement axis is orientated in the direction of earth's gravity the accelerometer should read a value of one times earth's gravity. If the acceleration is not equal to one times earth's gravity, then the accelerometer may have a different sensitivity from the accelerometer's datasheet value for sensitivity. This datasheet value for sensitivity can be corrected by a calibration term stored in the assign variables 156 section. Also, for example, if the device is not mounted in the same direction as the acceleration measurement axis there may be a vehicle angular orientation value stored in the assign variables 156 section that could be used to correct the acceleration value. If correction factors are not applied to the measurement of acceleration and/or gyroscope values, the measurement may have error which may be the difference between the true or real value of acceleration or angular velocity to the measured value of acceleration or angular velocity.

In some embodiments the main program 106 may take the motion sensor 110 values and compute a new distance at the current time sampled from the timer in a compute new distance 182 section. The process for computing a new distance includes taking the time from the sample motion sensor values 178 section, the acceleration or corrected acceleration from the apply correction factors 180 section, and the process of double integration compute the current distance traveled from the original position and/or from the previous time-step.

In some embodiments the main program 106 may take the current distance from the compute new distance 182 section and determine if the current distance is greater than a user defined rollout distance 150 defined in the EEPROM 112 which may be configurable by the user of the device in the menu program 108. If the current distance is less than the user-defined rollout distance 150, then the main program 106 may loop back to the sample motion sensor values 178 section.

In some embodiments during a distance greater than rollout distance 184 section, if the current distance is less than the user-defined rollout distance 150, the distance greater than rollout distance 184 section may compare the current acceleration level to an acceleration trigger level 186.

In some embodiments during the distance greater than rollout distance 184 section, if the current acceleration is greater than the acceleration trigger level 186 then the main program 106 may save the current time and compute the vehicle dead time 144 by computing the elapsed time between the current time and the vehicle start time 142 and save the vehicle dead time 144 to internal memory.

In some embodiments during the distance greater than rollout distance 184 section, if the current distance is greater than the user-defined rollout distance 150 then the main program 106 may compute the vehicle rollout time 148 by computing the elapsed time between the current time and the vehicle start time 142 and save the vehicle rollout time 148 to internal memory.

In some embodiments during the distance greater than rollout distance 184 section, if the current distance is greater than the user-defined rollout distance 150 then the main program 106 may compute the vehicle launch delay time 140 by computing the elapsed time between the vehicle start time 142 and the driver commanded start time 119 and save the vehicle launch delay time 140 to internal memory.

In some embodiments the distance greater than rollout distance 184 section may save to internal memory variables such as but not limited to the current time, current position, current vehicle rotational angle and/or orientation, vehicle dead time 144, vehicle launch delay time 140, and vehicle rollout time 148. These variables can be used in other sections of the main program 106 to store in internal memory or store in external memory to be displayed or viewed by the user.

In some embodiments after the distance greater than rollout distance 184 section the main program 106 may move to a false run detection 186 section. The false run detection 186 section may continue to record the acceleration of the vehicle in order to determine if the rollout distance 150 computed in the distance greater than rollout distance 184 section was due to a false run. A false run may indicate that the vehicle is not accelerating after a time limit say for example one second following the vehicle rollout time 148. For example, if the vehicle is accelerating after say, one second following the vehicle rollout time 148 then it would be likely that the vehicle rollout time 148 was determined on an actual run and not a false run. Also, for example, if the vehicle is not accelerating after one second following the vehicle rollout time 148, then the vehicle rollout time 148 could be erroneous as a result of a false run.

If a false run is detected in the false run detection 186 section, then the main program 106 may not save or store any recent variables such as but not limited to the current time, current position, current vehicle rotational angle and/or orientation, vehicle dead time 144, vehicle launch delay time 140, and vehicle rollout time 148. If a false run is detected in the false run detection 186 section, then the main program 106 may return to the check run review 160 section.

In some embodiments if no false run is detected in the false run detection 186 section, then the main program 106 may move to a store vehicle reaction times 188 section. The store vehicle reaction times 188 section may store variables such as but not limited to the current time, current position, current vehicle rotational angle and/or orientation, vehicle dead time 144, vehicle launch delay time 140, and vehicle rollout time 148 to an internal and/or external memory device to be reviewed later by the driver or user.

In some embodiments after the store vehicle reaction times 188 section the main program 106 may move to the display vehicle reaction times 164 section. The display vehicle reaction times 164 section may display variables such as but not limited to the current time, current position, current vehicle rotational angle and/or orientation, vehicle dead time 144, vehicle launch delay time 140, and vehicle rollout time 148 to the display 116 of the device to be reviewed by the driver or user.

In some embodiments after the display vehicle reaction times 164 section the main program 106 may return to the check run review 160 section. After the main program 106 returns to the check run review 160 section the main program 106 may repeat the main program 106 and/or menu program 108 as described herein and repeat indefinitely unless power is removed from the device.

In some embodiments it may be helpful to reset the vehicle reaction timer 100 and return to a starting point in the main program 106. This reset may occur in a reset 190 function where maybe if the left control switch 120 is pulled backward or say down then the reset 190 function would be enabled and return the main program 106 to the initialize components 154 section.

### Programmability

In some embodiments vehicle reaction timers may be programmed to accept a plurality of mounting orientations in or on the vehicle. In order for the vehicle reaction timer 100 to provide accurate results, mounting of the vehicle reaction timer 100 becomes very important. If the vehicle reaction timer 100 is not mounted on a rigid surface but on a less than rigid surface the vehicle reaction timer 100 may experience additional vibrations and frequencies. A better mounting surface for a vehicle reaction timer would be a rigid surface let's say for example on a portion of the vehicle's chassis. Since mounting a vehicle reaction timer requires a rigid mounting location, the number of available locations may be reduced. In some cases where to mount a vehicle reaction timer may be difficult due to existing components such as for example vehicle wiring, vehicle subsystems, other devices, and other components. In some cases, mounting may be difficult due to available space. In some locations of a vehicle mounting a vehicle reaction timer may make it difficult for the driver or crew member to visually see the display 116 feature on the device. Vehicle reaction timers with the ability to be programmed to mount in a plurality of locations reduces the difficulty of mounting in a preferred location. Since the MEMS motion sensor with an accelerometer and gyroscope have multiple axis for example x, y, and z axes on the accelerometer and gyroscope, acceleration and rotational velocity can be determined in three orthogonal directions. This feature of the MEMS sensor allows the vehicle reaction timer 100 to be programmed to be mounted with an orientation along any of these axes or orthogonal directions. Although some embodiments in the present disclosure describe mounting vehicle reaction timers in orthogonal directions, other embodiments of vehicle reaction timers may be programmed to mount in any orientation not orthogonal to the x, y, and z axes.

In some embodiments vehicle reaction timers may be user-programmable to accept different polarities of electrical connections to signal a driver commanded start time 119 or the vehicle start time 142. In some vehicles, the signals generated by the delay box can be used by the vehicle reaction timer 100 as a signal for to indicate the driver commanded start time 119 event or a vehicle start time event. One type of delay box may require the transbrake button switch to be wired to electrical ground while another type of delay box may require the transbrake button switch to be wired to positive battery voltage. Different types of delay boxes can have different polarity output for both the vehicle start time 142 and driver commanded start time 119 inputs the vehicle reaction timer 100. Therefore, it may be beneficial for a vehicle reaction timer to have the ability for the driver or user to configure the device to accept different polarities.

In some embodiments vehicle reaction timers may be user-programmable to set a plurality of thresholds to trigger upon detection of vehicle acceleration. Some drag racing vehicles have more powerful engines and are capable of higher accelerations while other vehicles have lower powered engines and are only capable of lower accelerations. Some vehicle reaction timers may have a user-programmable feature to allow the user to set an acceleration threshold to detect the dead time of a vehicle.

In some embodiments vehicle reaction timers may be user-programmable to set a plurality of thresholds to trigger upon detection of a vehicle reaching the rollout distance 150. Some vehicles may have a rollout distance 150 as long as a distance of say eight inches for a small front tire with a lower beam height or say eleven and a half inches for a standard size front tire and standard starting line stage beam height or even say twenty inches for a larger front tire with front wheel stagger and a higher starting line stage beam height. Due to the plurality of rollout distance 150 a vehicle reaction timer may be user-programmable to set a plurality of thresholds to trigger upon detection of a vehicle reaching the rollout distance 150.

In some embodiments vehicle reaction timers may be user-programmable to accept different launch modes of a drag racing vehicle. As discussed herein a vehicle may be launched from a plurality of launch modes such as a top bulb launch, bottom bulb launch, transbrake launch, clutch launch, and footbrake launch. A vehicle reaction timer may be user-programmable to accept different launch modes of a drag racing vehicle. For example, the vehicle start time 142 can occur when the transbrake solenoid is deactivated in a transbrake launch or can occur when the driver performs a footbrake launch when a sensor placed near or on either the accelerator pedal or the brake pedal sends a signal to the vehicle reaction timer 100 indicating a vehicle start time event. Although the examples provided may show different modes of launching a vehicle, they are not an exhaustive list of the possible ways to launch a vehicle.

### Motion Sensor

In some embodiments vehicle reaction timers may measure acceleration of drag racing vehicles using a motion sensor that includes an accelerometer or accelerometers. The type of accelerometer that may be used is what are known as MEMS accelerometers. MEMS accelerometers are small devices typically encased in a silicon die and commonly found in devices such as smartphones and tablets and are small enough to mount and communicate with electrically on a circuit board. The sensor uses stationary fingers and floating fingers with a known mass and when acceleration occurs the floating fingers move and cause a capacitance change between the stationary and floating fingers. The capacitance change could be converted to a voltage to be measured by the motion sensor 110 device and reported to the registers of the motion sensor 110 device.

In some embodiments vehicle reaction timers may include methods to measure acceleration of drag racing vehicles using a motion sensor that includes a multi-axis accelerometer. Multi-axis accelerometers take advantage of the small footprint of MEMS accelerometers and include say for example an X-axis, a Y-axis, and a Z-axis all in the same motion sensor. This allows the device to be mounted in multiple orientations in the vehicle making it easier for the driver and/or crew member to mount, operate, and/or view the device.

Using MEMS type accelerometers for motion sensing has many benefits such as a small footprint and multiple axis capabilities. Using MEMS accelerometers in low vibration or low vibration frequency environments and applications such as monitoring step counts in a smartphone work great but using MEMS devices in environments with high sound and vibration levels, high sound and vibration frequencies, and the harsh environment of a racecar comes with tough challenges. Using any accelerometer for dead reckoning applications such as determining vehicle rollout time may have some level of error associated with the acceleration measurement. MEMS accelerometers are often thought to be more affected negatively by high frequency vibrations. When integrating to calculate velocity and integrating to calculate distance this error may be multiplied, and the position measurement can become erroneous only after a fraction of one second or maybe after a few seconds. The reason this error multiples can be due to the MEMS accelerometer unable to detect vibration at higher frequencies often seen in a racecar. The acceleration levels and frequencies are often higher than the accelerometers measurement bandwidth or its ability to capture these high frequency vibrations. This results in vibrations which are often lost and not measured and therefore error may be accumulated in the position measurement. Some techniques are available to filter out high frequency vibrations either electrically in the form of a capacitor or in software as a low-pass filter. These techniques often are successful but in the application of drag racing vehicles these techniques may not have much success. The best form of a low-pass filter may be a mechanical low-pass filter in the form of a dampening system.

In some embodiments vehicle reaction timers may use a dampening system in order to filter out high frequency vibrations. As stated herein high vibrations can cause acceleration values to be missed which can accumulate error in the vehicle reaction time measurements. The device described herein may use a type of dampening system to mechanically isolate high vehicle vibrations and only allow low frequency vibrations to pass through to the sensor effectively creating a mechanical low-pass filter. The embodiments of the present disclosure

In some embodiments vehicle reaction timers may use a gyroscope or multiple gyroscopes to measure angular rate of rotation. The launching of a drag racing vehicle may be a non-linear and violent event with forces acting in many directions other than forces to propel the vehicle forward. Rotational forces such as engine torque can twist the chassis of the vehicle and cause a change in orientation. Other rotational forces such as the torque of the rear wheels used to drive the vehicle forward also are powerful enough to rotate the vehicle upward causing the front wheels of the vehicle to rise off the racing surface. The torque of the rear wheels can be high enough to cause the rear tires to deform and become distorted in a way which drops the rear wheel axel centerline closer the racing surface. These are only a few examples and not an exhaustive list of additional forces in launching a racecar besides the main forward accelerative force. Unfortunately, in some racecars these additional forces are enough to cause error to the vehicle reaction timer 100 when measuring rollout time. The primary reason this error accumulates may be because the additional forces cause the vehicle's chassis to rotate which causes the gravitational force due to earth's gravity to affect the acceleration measurement. In order to account for this gravitational force a gyroscope may be used as a corrective device to determine how much of the acceleration is due to forward acceleration and how much is due to earth's gravity.

In some embodiments vehicle reaction timers may use a gyroscope or multiple gyroscopes to measure and record the vehicle angle of rotation at the rollout distance 150. In some types of drag racing vehicles high powered engines combined with short wheelbase vehicles cause the front wheels to rise during a launch known as a wheel stand. When a vehicle launches, and wheel stands there may be the chance the vehicle's front tires can rise out of the starting line stage beam instead of rolling through it. This can cause the reaction time recorded by the racetracks timing system to be quicker and inconsistent causing a red light, an instant disqualification from the vehicle rolling out of the starting line stage beam before the green light illuminates on the Christmas tree. If a gyroscope is used to record vehicle rotation, the vehicle angle with respect to the racing surface can be recorded at an arbitrary distance for example at the rollout distance 150. This angle may then be stored to be reviewed later by the driver or crew member and may be capable of alerting the driver or crew member of a possible wheel stand capable of causing a red light.

Although some embodiments of the present disclosure are depicted as being used and employed as a vehicle reaction timer to measure vehicle rollout time, persons of ordinary skill in the art would understand that the embodiments of the present disclosure may be employed in other implementations such as, for example, measuring the vehicles elapsed time to a longer distance than the vehicle rollout time before the racetracks first timing cone at 60 feet past the starting line beam (e.g., 10 feet, 20 feet, 30 feet, etc.).

Although some embodiments of the present disclosure are depicted as being used and employed as a vehicle reaction timer to measure reaction times of a drag racing vehicle, persons of ordinary skill in the art would understand that the embodiments of the present disclosure may be employed in other implementations such as, for example, the vehicle reaction time of all forms of vehicle transportation (e.g., civilian production vehicle, watercraft, aircraft etc.).

The illustrations presented herein are not meant to be actual views of any particular vehicle reaction timer or component thereof but are merely idealized representations employed to describe illustrative embodiments. The drawings are not necessarily to scale. Elements common between figures may retain the same numerical designation.

As used herein, relational terms, such as “first,” “second,” “top,” “bottom,” etc., are intended to provide clarity and facilitate understanding of the disclosure and accompanying drawings. These terms do not imply or rely on any particular preference, orientation, or order, except where the context unmistakably indicates otherwise.

As used herein, the term “and/or” means and includes any and all conceivable combinations of one or more of the associated listed items.

As used herein, the term “side” refers to the orientation as depicted in the figures.

The relational terms such as “first,” “second,” “top,” “bottom,” etc., employed in this document are meant to enhance clarity and ease of understanding in the disclosure and accompanying drawings. These terms do not imply or rely on any specific preference, orientation, or order, unless it is evident from the context.

As used herein, the terms “commonly” or “sometimes” as used in this document regarding a specific parameter signify that the given parameter, property, or condition has been satisfied to an extent that would be recognized by a skilled individual in the relevant field, even with occasional fluctuations, such as occurring from time to time or intermittently. For instance, a parameter that is commonly or sometimes referred to may mean that it is referred to 20%, at least 55%, at least 80%, or even 100% of the time.

As used herein, the terms “substantially” or “about,” as employed in this document with respect to a specific parameter, refer to the level at which a person skilled in the art would recognize that the parameter, property, or condition in question has been achieved, even with a small degree of variance within acceptable manufacturing tolerances. To clarify, a parameter that is “substantially met” could mean that it has been met to a degree of at least 90%, 95%, 99%, or even 100%.

Although the disclosed embodiments have been presented herein in a specific manner, individuals with ordinary skills in the relevant field will understand that these embodiments are not the only possible ones. Various modifications, deletions, and additions to the disclosed embodiments can be made without straying from the scope of the claims included hereinafter, which also includes any legal equivalents. Moreover, it is possible to merge features from one embodiment with features from another embodiment, and still remain within the scope of the disclosure envisioned by the inventor.

What is claimed is:

1. A device for determining the reaction time of a vehicle, the device comprising:
a signal receiver configured to accept an electrical signal indicating the moment when the vehicle is commanded to accelerate or the moment when the vehicle's brake is released;
at least one accelerometer configured to measure the acceleration of the vehicle;
at least one microprocessor unit electrically connected to the at least one accelerometer, the microprocessor unit being configured to:
i. calculate the elapsed time of timing events from the moment the vehicle is commanded to accelerate;
ii. derive the vehicle's position based on the measured acceleration and the calculated elapsed time;
iii. execute a method for determining vehicle rollout time, wherein the rollout time is defined as the elapsed time from the vehicle start time to the time when the vehicle reaches a predefined rollout distance from the vehicle starting position, utilizing the measured acceleration, derived vehicle position, calculated elapsed time, and electrical signals indicated from the signal receiver.

2. The device of claim 1, wherein the at least one microprocessor unit is further configured to execute a method for determining vehicle dead time, wherein the dead time is defined as the elapsed time from the vehicle start time to the time when the vehicle acceleration reaches a predefined threshold of acceleration indicating initial movement, utilizing the measured acceleration, and the electrical signals indicated from the signal receiver to determine the dead time.

3. The device of claim 1, wherein the at least one microprocessor unit is further configured to execute a method for determining vehicle launch delay time, wherein the launch delay time is defined as the elapsed time between the vehicle's driver commanded start time and vehicle start time, utilizing the electrical signals indicated from the signal receiver to determine the launch delay time.

4. The device of claim 1, wherein the vehicle's driver commanded start time is determined from a means of producing electrical signals from the position of the driver's accelerator pedal to determine the said vehicle's driver commanded start time.

5. The device of claim 1, wherein the vehicle start time is determined from a means of producing electrical signals from the position of the driver's accelerator pedal to determine the said vehicle's driver commanded start time.

6. The device of claim 1, wherein the vehicle's driver commanded start time is determined from a means of producing electrical signals from the driver's means of engaging or disengaging of the vehicle's transbrake to determine the said vehicle's driver commanded start time.

7. The device of claim 1, wherein the vehicle start time is determined from a means of producing electrical signals from the vehicle's means of engaging or disengaging of the vehicle's transbrake to determine the said vehicle start time.

8. The device of claim 1, wherein the vehicle start time is determined from a means of producing electrical signals from the vehicle's means of engaging or disengaging of the vehicle's brake to determine the said vehicle start time.

9. The device of claim 1, further comprising a circuit board comprising a means of mechanical and electrical connection between the at least one accelerometer, the signal receiver, and the at least one microprocessor which executes the method for determining vehicle rollout time, the method for determining vehicle dead time, and the method for determining vehicle launch delay time.

10. The device of claim 1, further comprising a housing comprising a means of mechanical connection to the circuit board in at least one point of contact or a plurality of points of contact.

11. The device of claim 1, wherein the housing further comprises a cylindrically rounded geometric feature as a means to mechanically connect the said housing and said housing dampening structure to the vehicle.

12. The device of claim 1, wherein the at least one accelerometer has at least one axis of acceleration measurement as in a single-axis accelerometer or a plurality of axis of acceleration measurement as in a two-axis accelerometer or as in a three-axis accelerometer.

13. The device of claim 1, further comprising an electronic display electrically connected or connected via wireless communication to the microprocessor with means of displaying said vehicle's rollout time, vehicle's dead time, or vehicle's launch delay time in a numeric or alphanumeric format on the said device or external to the said device.

14. The device of claim 1, further comprising a means for displaying a numeric or alphanumeric format on said device comprising greater than two numeric or two alphanumeric digits to display timing events such as vehicle launch delay time, vehicle dead time, and vehicle rollout time.

15. The device of claim 1, further comprising an electrical memory device electrically connected to the vehicle rollout time determining electronic device, vehicle dead time determining electronic device, and vehicle launch delay time determining electronic device for electrically storing data from the vehicle rollout time determining electronic device, vehicle dead time determining electronic device, and vehicle launch delay time determining electronic device.

16. The device of claim 1, wherein the electrical memory device can store multiple or more than one instance of vehicle's rollout time, vehicle's dead time, or vehicle's launch delay time and may display one or more instances of vehicle's rollout time, vehicle's dead time, or vehicle's launch delay time on the said electrical display in numeric or alphanumeric format.

17. The device of claim 1, further comprising a removable electrical memory device electrically connected to the vehicle rollout time determining electronic device, and the said at least one accelerometer for electrically storing multiple vehicle acceleration values in order to be reviewed.

18. A device for mounting to a vehicle, the device comprising:
a housing with a cylindrical concave surface complementary to the curvature of a vehicle's frame;
at least one accelerometer configured to measure the acceleration of the vehicle;
at least one microprocessor unit electrically connected to the at least one accelerometer;
a circuit board that is mechanically attached to the at least one accelerometer, the at least one microprocessor, and the housing;
a saddle configured to mount onto a vehicle's frame, the saddle having a cylindrical concave surface complementary to the curvature of a vehicle's frame for means of securing the saddle to the vehicle's frame;
and a dampening structure formed of a material configured to reduce vibrations from the vehicle's frame, the dampening structure interposed between the housing to the saddle at one or more damping points to reduce externally induced vibrations from the vehicle.

19. (canceled)

20. (canceled)
